(19) United States
(12) Patent Application Publication
(10) Pub. No.: US 2008/0145551 A1
(43) Pub. Date: Jun. 19, 2008

(54) METHOD OF MANUFACTURING MULTILAYER ELECTRONIC COMPONENT

(75) Inventors: Tatsuo KUNISHI, Moriyama-shi (JP); Makoto OGAWA, Fukui-shi (JP); Akihiro MOTOKI, Fukui-shi (JP)

Correspondence Address: MURATA MANUFACTURING COMPANY, LTD.;C/O KEATING & BENNETT, LLP, 8180 GREENSBORO DRIVE, SUITE 850, MCLEAN, VA, 22102, US

(73) Assignee: MURATA MANUFACTURING CO., LTD., Nagaokakyo-shi (JP)

(21) Appl. No.: 12/041,889

(22) Filed: Mar. 4, 2008

Related U.S. Application Data
(63) Continuation of application No. PCT/JP2007/052455, filed on Feb. 13, 2007.

(30) Foreign Application Priority Data
Mar. 14, 2006 (JP) 2006-069225

(51) Int. Cl. B05D 1/18; B05D 5/12

(52) U.S. Cl. 427/430.1; 427/58

(57) ABSTRACT

An electroless plating step for forming external electrodes includes preparing a plating solution including a reducing agent and metal ions having a more electochemically positive deposition potential than the oxidation-reduction potential of the reducing agent, placing a laminate for a multilayer electronic component together with a conductive medium having catalytic activity for an oxidation reaction of the reducing agent in a vessel, and stirring the laminate and the conductive medium in the plating solution by rotation, shaking, inclination, or vibration. Electroless plating proceeds to connect each other plating deposits deposited on the ends of a plurality of internal electrodes.

### BACKGROUND OF THE INVENTION

1. Field of the Invention

The present invention relates to a method of manufacturing a multilayer electronic component, and particularly to a method of manufacturing a multilayer electronic component in which external electrodes are formed directly on the outer surfaces of a laminate by electroless plating.

2. Description of the Related Art

As shown in FIG. 11, a multilayer electronic component 101 represented by a multilayer ceramic capacitor includes a laminate 105 including a plurality of stacked insulator layers 102 and a plurality of internal electrodes 103 and 104 arranged along the interfaces between the respective insulator layers. The ends of the plurality of internal electrodes 103 and 104 are exposed at the ends 106 and 107, respectively, of the laminate 105, and external electrodes 108 and 109 are arranged to electrically connect the ends of the internal electrodes 103 and 104, respectively.

To form the external electrodes 108 and 109, metal paste including a metal component and a glass component is applied on the ends 106 and 107 of the laminate 105 and then baked to form paste electrode layers 110. Next, a first plating layer 111 including Ni as a main component is formed on each of the paste electrode layers 110, and a second plating layer 112 including Sn as a main component is further formed on the first plating layer 111. Thus, each of the external electrodes 108 and 109 has a three-layer structure including the paste electrode layer 110, the first plating layer 111, and the second plating layer 112.

The external electrodes 108 and 109 must have high wettability with solder when the multilayer electronic component 101 is mounted on a substrate using solder. At the same time, the external electrode 108 must function to electrically connect the plurality of internal electrodes 103 which are electrically insulated from each other, and the external electrode 109 must function to electrically connect the plurality of internal electrodes 104 which are electrically insulated from each other. The function to secure solder wettability is achieved by the second plating layers 112, and the function to electrically connect the internal electrodes 103 and 104 is achieved by the paste electrode layers 110. The first plating layers 111 function to prevent solder leaching during soldering.

However, the paste electrode layers 110 have a thickness of several tens μm to several hundreds μm. Therefore, in order to achieve predetermined standard dimensions of the multilayer electronic component 101, it is necessary to decrease an effective volume for obtaining a capacitance because of the relatively large volume required for the paste electrode layer 110. On the other hand, the plating layers 111 and 112 have a thickness of several μm. Therefore, if each of the external electrodes 108 and 109 can be defined by only the first and second plating layers 111 and 112, a greater effective volume for obtaining a capacitance can be provided.

For example, Japanese Unexamined Patent Application Publication No. 2004-146401 discloses a method in which conductive paste is applied to at least the edges at the ends of a laminate along the lamination direction of internal electrodes so as to be in contact with exposed portions of the internal electrodes, the conductive paste is baked or thermally cured to form conductive films, and electroplated films are formed by electroplating on the ends of the laminate so as to be connected to the conductive films at the edges. This method decreases the thickness of the external electrodes at the ends.

Japanese Unexamined Patent Application Publication No. 63-169014 discloses a method in which conductive metal films are deposited by electroless plating over the entire surfaces of the side walls of a laminate, in each of which internal electrodes are exposed, so that the internal electrodes exposed in the side walls are short-circuited.

However, in the method of forming the external electrodes described in Japanese Unexamined Patent Application Publication No. 2004-146401, the exposed internal electrodes can be connected directly to the electroplated films. However, the conductive portions must be formed using conductive paste such that the exposed portions of the exposed internal electrodes are previously made electrically conductive prior to the electroplating. The step of applying the conductive paste to specific portions is difficult.

On the other hand, the electroless plating method described in Japanese Unexamined Patent Application Publication No. 63-169014 has a problem in that the formed plating films have low density and homogeneity, and a plating solution easily penetrates into the laminate to decrease reliability. A possible method for overcoming this problem includes applying a substance having high catalytic activity, such as Pd, on a surface to be plated before plating films are formed. In an embodiment described in Japanese Unexamined Patent Application Publication No. 63-169014, this method is used. However, there is a problem in that the step of applying a catalyst is complicated, and the plating films are easily deposited in portions other than desired portions.

Furthermore, the method described in Japanese Unexamined Patent Application Publication No. 63-169014 uses Pd or Pt as a material for the internal electrodes provided in the laminate. However, Pd and Pt are used as metals having high catalytic activity for a reaction of a reducing agent in electroless plating. Thus, there is a problem of a low degree of freedom of the selection of a metal material to be used for the internal electrodes. In addition, since Pd and Pt are expensive noble metals, there is a problem of increasing the cost of a multilayer electronic component.

Furthermore, in the method described in Japanese Unexamined Patent Application Publication No. 63-169014, the thickness of the internal electrodes must be at least about 1 μm, and thus, there is a problem of increasing the size of a laminate and increasing the cost of a multilayer electronic component.

### SUMMARY OF THE INVENTION

To overcome the problems described above, preferred embodiments of the present invention provide a method of manufacturing a multilayer electronic component having an improved effective volume ratio in which an external electrode is substantially formed using only a plating deposit.

Preferred embodiments of the present invention also provide a method of manufacturing a multilayer electronic component capable of simply forming an external electrode composed of a dense plating film without complicated previous steps, e.g., a step of coating conductive paste and a step of applying a catalyst, and capable of ensuring high reliability.

A method of manufacturing a multilayer electronic component according to a preferred embodiment of the present invention includes a step of preparing a laminate including a plurality of stacked insulator layers and a plurality of internal electrodes formed along the interfaces between the respective insulator layers, the ends of the internal electrodes being exposed at a predetermined surface and the adjacent internal electrodes being electrically insulated from each other in the predetermined surface, and a step of forming an external electrode on a predetermined surface of the laminate so that the ends of the plurality of internal electrodes exposed in the predetermined surface of the laminate are electrically connected to each other. In order to overcome the above-mentioned problems, various preferred embodiments of the present invention include the following features.

The step of forming the external electrode includes an electroless plating step of electroless plating on the ends of the plurality of internal electrodes, which are exposed in the predetermined surface of the laminate prepared in the step of preparing the laminate, using a reducing agent and a plating solution including metal ions having a deposition potential that is more electrochemically positive than the oxidation-reduction potential of the reducing agent.

The electroless plating step includes a step of preparing a conductive medium having catalytic activity for an oxidation reaction of the reducing agent, a step of stirring the conductive medium and the laminate in the plating solution, and a step of growing the plating deposits on the ends of the plurality of internal electrodes so that the plating deposits are connected to each other.

The step of stirring the conductive medium and the laminate in the plating solution is preferably performed by rotating, shaking, inclining, or vibrating the conductive medium and the laminate in the plating solution in a vessel.

In preferred embodiments of the present invention, the average diameter of the conductive medium is preferably at least about 0.2 mm, for example.

When the reducing agent is a phosphoric acid compound, preferably, the metal ions in the plating solution are at least one of Ni ions, Co ions, and Au ions, and at least the surface of the conductive medium is composed of at least one of Au, Ni, Co, and Pt, or an alloy thereof. More preferably, the phosphoric acid compound is hypophosphorous acid or a hypophosphite, and the metal ions in the plating solution are Ni ions.

When the reducing agent is a boric acid compound, preferably, the metal ions in the plating solution are at least one of Ni ions, Co ions, Pt ions, and Au ions, and at least the surface of the conductive medium is composed of at least one of Au, Ni, Co, and Pt, or an alloy thereof.

When the reducing agent is a nitrogen compound, preferably, the metal ions in the plating solution are at least one of Ni ions, Co ions, Pt ions, and Au ions, and at least the surface of the conductive medium is composed of at least one of Co, Ni, and Pt, or an alloy thereof.

When the reducing agent is an aldehyde compound, preferably, the metal ions in the plating solution are at least one of Ag ions, Cu ions, and Au ions, and at least the surface of the conductive medium is composed of at least one of Ag, Cu, and Au, or an alloy thereof.

In the laminate prepared in the step of preparing the laminate, the distance between the adjacent internal electrodes, which is measured in the thickness direction of the insulator layers in the predetermined surface in which the internal electrodes are exposed, is preferably about 20 μm or less, and the withdrawn length of the internal electrodes from the predetermined surface is preferably about 1 μm or less, for example.

Alternatively, in the laminate prepared in the step of preparing the laminate, the distance between the adjacent internal electrodes, which is measured in the thickness direction of the insulator layers in the predetermined surface in which the internal electrodes are exposed, is preferably about 50 μm or less, and the protrusion length of the internal electrodes from the predetermined surface is preferably at least about 0.1 μm, for example.

The withdrawn length or protrusion length of the internal electrodes is preferably controlled in a step of abrading the laminate with an abrasive agent before the step of forming the external electrodes.

The main component of the internal electrodes is preferably at least one of Ni, Cu, and Ag.

According to preferred embodiments of the present invention, a multilayer electronic component having an increased effective volume ratio is obtained because an external electrode of the multilayer electronic component is substantially formed using only a plating deposit.

According to preferred embodiments of the present invention, it is possible to simply form at least a portion of an external electrode which is directly connected to the internal electrodes using a dense electroless plating deposit having high homogeneity without complicated previous steps, e.g., a step of coating conductive paste and a step of applying a catalyst. As a result, a multilayer electronic component which maintains high reliability is obtained.

Further, according to preferred embodiments of the present invention, an electroless plating film having a high density is obtained without using a metal having high catalytic activity, such as Pd or Pt, as the main component of the internal electrodes. Therefore, an inexpensive metal material, such as Ni, Cu, or Ag, can be used for the internal electrodes, and thus, a multilayer electronic component can be obtained at a reduced cost.

Further, even when the thickness of the internal electrodes is less than about 1 μm, a dense electroless plating film is formed, and thus, a small multilayer electronic component is obtained at a reduced cost.

When the average diameter of the conductive medium is at least about 0.2 mm, the formation efficiency of a plating film is further improved.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a sectional view showing a multilayer electronic component obtained by a manufacturing method according to a first preferred embodiment of the present invention.

FIG. 2 is an enlarged sectional view showing a portion in which internal electrodes of a laminate shown in FIG. 1 are exposed.

FIG. 3 is a sectional view showing a state in which plating deposits are deposited on exposed portions of the internal electrodes shown in FIG. 2.

FIG. 4 is a sectional view showing a state in which the plating deposits deposited in FIG. 3 are grown.

FIG. 5 is a sectional view showing a state in which the plating deposits grown in FIG. 4 are integrated to form a first plating layer.

FIG. 6 is a sectional view corresponding to FIG. 2 and illustrating a manufacturing method according to a second preferred embodiment of the present invention.

FIG. 7 is a sectional view corresponding to FIG. 6 and illustrating a manufacturing method according to a third preferred embodiment of the present invention.

FIG. 8 is a perspective view showing another example of a multilayer electronic component obtained by a manufacturing method according to a preferred the present invention.

FIG. 9 is a sectional view showing a state in which a multilayer electronic component shown in FIG. 8 is mounted on a substrate.

FIG. 10 is a sectional view showing a state in which a multilayer electronic component shown in FIG. 1 is mounted on a substrate.

FIG. 11 is a sectional view showing a conventional multilayer electronic component.

### DETAILED DESCRIPTION OF THE PREFERRED EMBODIMENTS

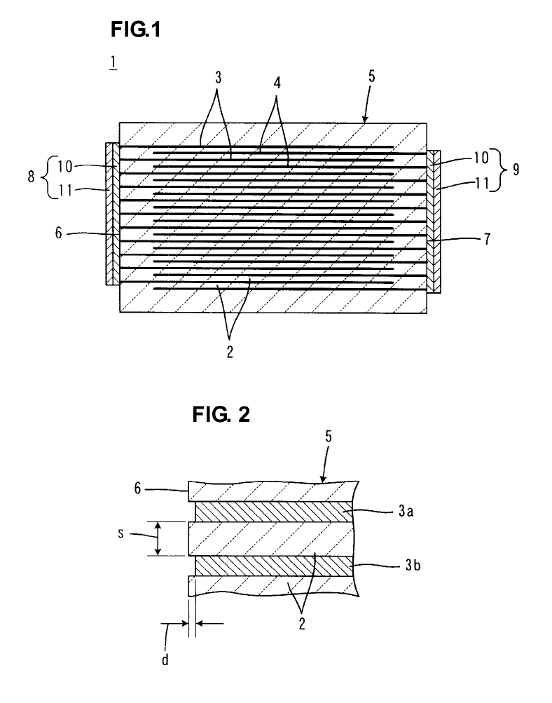

A method of manufacturing a multilayer electronic component according to a first preferred embodiment of the present invention will be described with reference to FIGS. 1 to 5.

As shown in FIG. 1, a multilayer electronic component 1 includes a laminate 5 including a plurality of stacked insulator layers 2 and a plurality of layer-shaped internal electrodes 3 and 4 formed along the interfaces between the respective insulator layers 2. When the multilayer electronic component 1 defines a multilayer ceramic capacitor, the insulator layers 2 are composed of dielectric ceramic. The ends of a plurality of the internal electrodes 3 and the ends of a plurality of the internal electrodes 4 are exposed at the end surfaces 6 and 7, respectively, of the laminate 5, and external electrodes 8 and 9 are formed to electrically connect the ends of the internal electrodes 3 and the internal electrodes 4, respectively.

Each of the external electrodes 8 and 9 is substantially composed of a plating deposit and includes a first plating layer 10 formed on each of the end surfaces 6 and 7 at which the internal electrodes 3 and 4, respectively, are exposed, and a second plating layer 11 formed on the first plating layer 10.

The second plating layer 11 defining the outermost layer is preferably composed of Sn or Au as a main component because it must high solder wettability. The first plating layer 10 is preferably composed of Ni as a main component because it must function to electrically connect the plurality of internal electrodes 3 or 4, which are electrically insulated from each other, and to prevent solder leaching during soldering.

The first plating layer 10 directly connected to the internal electrodes 3 or 4 is formed by electroless plating to deposit metal ions using a reducing agent, but is not formed by electrolytic plating by applying electricity.

When the first plating layer 10 is formed by electroless plating, a catalytic material, e.g., Pd, is typically applied to accelerate a reduction reaction of the reducing agent to a surface on which a plating film is to be formed before the electroless plating step. However, according to preferred embodiments of the present invention, the step of applying such a catalytic material is not provided. Therefore, a uniform layer composed of the catalytic material is not disposed between the first plating layer 10 and each of the end surfaces 6 and 7 at which the internal electrodes 3 and 4, respectively, are exposed. In addition, a film formed directly on each of the end surfaces 6 and 7 at which the internal electrodes 3 and 4, respectively, are exposed does not include a conductive paste film, a vacuum deposited film, and a sputtered film.

Next, a method of manufacturing the multilayer electronic component 1 shown in FIG. 1 will be described primarily with respect to a method of forming the external electrodes 8 and 9, particularly the first plating layers 10, with reference to FIGS. 2 to 5.

FIG. 2 is an enlarged view showing a vicinity of the end surface 6 of the laminate 5 shown in FIG. 1, at which the internal electrodes 3 are exposed. FIG. 2 shows a state before the external electrode 8 is formed. Among the many internal electrodes 3, the two internal electrodes located in a region shown in FIG. 2 are extracted and denoted by reference numerals 3a and 3b. FIG. 2 shows an arbitrarily selected portion near the end surface 6 at which the internal electrodes 3 are exposed, but does not show the specified internal electrodes 3. In this state, the plurality of internal electrodes 3 represented by the internal electrodes 3a and 3b are electrically insulated from each other.

The other end surface 7 and the internal electrodes 4 exposed at the end surface 7 are substantially the same as the end surface 6 and the internal electrodes 3, and thus figures and a description thereof are omitted.

In order to form the first plating layer 10, first, the laminate 5 shown in FIG. 2 is disposed in a vessel which is filled with the reducing agent and a plating solution including metal ions having a higher electrochemically positive potential than the oxidation-reduction potential of the reducing agent. A conductive medium having catalytic activity for an oxidation reaction of the reducing agent is charged in the vessel. At least the surface of the conductive medium may be composed of a material exhibiting catalytic activity, and the inside material of the medium is not particularly limited.

Next, the vessel is rotated, shaken, inclined, or vibrated to stir the laminate 5 and the conductive medium in the plating solution. Consequently, the conductive medium is brought into contact with the end surface 6 of the laminate 5 at which the internal electrodes 3a and 3b are exposed. At the same time, the reducing agent is oxidized by the catalytic function of the conductive medium to supply electrons produced by the oxidation function to the internal electrodes 3a and 3b.

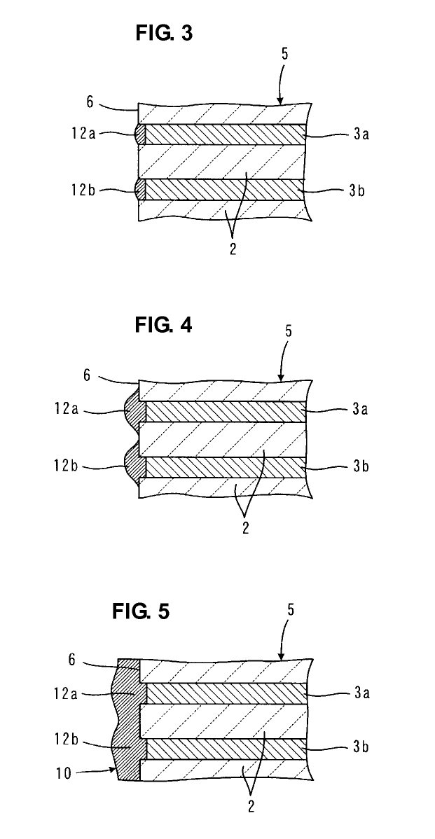

The metal ions in the solution receive the supplied electrons and are deposited as a metal on the surface at which the internal electrodes 3a and 3b are exposed. FIG. 3 shows a state in which the plating deposits 12a and 12b are deposited on the exposed surfaces. In this state, the internal electrodes 3a and 3b are electrically insulated from each other.

When the electroless plating step is further continued, deposition of the metal ions further proceeds with the plating deposits 12a and 12b functioning as nuclei, and the plating deposits 12a and 12b are further grown. This state is shown in FIG. 4. Since the deposits 12a and 12b have a catalytic function for the reducing agent, deposition of the metal ions is accelerated as the plating deposits 12a and 12b are increased in size.

When the electroless plating step is further continued, deposition of the metal ions proceeds further, and the grown plating deposits 12a and 12b contact each other so as to be integrated. When this state proceeds, the first plating layer 10 electrically connects the plurality of internal electrodes 3 which are exposed. This state is shown in FIG. 5.

The phenomenon shown in FIGS. 2 to 5 is caused by the high growth force of the plating deposits 12a and 12b. The plating deposits 12a and 12b tend to extend in a direction parallel to the end surface 6 during growth, and the plating deposits 12a and 12b tend to be integrated when coming into contact with each other. The growth force of the plating deposits 12a and 12b can be controlled by changing the conditions, such as the metal ion concentration, additives, and temperature in the plating bath.

Note that the conductive medium has catalytic activity for the reducing agent, and thus, a dense plating layer can be formed without a previous step of applying a catalyst. Further, the conductive medium strengthens an adhesion of the plating deposits 12a and 12b on the exposed ends of the internal electrodes 3a and 3b, and thus, improves the density of the formed first plating layer 10.

With respect of the size of the conductive medium, the average diameter is preferably at least about 0.2 mm. When the diameter is at least about 0.2 mm, the deposition efficiency of the plating deposits 12a and 12b on the exposed ends of the internal electrodes 3a and 3b is increased.

Next, a description is provided of the metal ion type and the material of the conductive medium to the specified type of the reducing agent. Typical examples of the reducing agent include a phosphoric acid type, a boron type, a nitrogen type, and an aldehyde type. These four types of reducing agents are described below.

Examples of the phosphoric acid reducing agent include sodium hypophosphite (NaH₂PO₂), and examples of a material with catalytic activity for an oxidation reaction thereof include Au, Ni, Co, and Pt. The material of at least the surface of the conductive medium may be at least one of these materials. In this case, the metal ions may be at least one of Ni ions, Co ions, and Au ions.

Examples of the boron reducing agent include sodium tetraborate (NaBH₄) and dimethylamine borane ((CH₃)₂NHBH₃), and examples of a material with catalytic activity for an oxidation reaction of the reducing agent include Au, Ni, Co, and Pt. The material of at least the surface of the conductive medium may be at least one of these materials. In this case, the metal ions may be at least one of Ni ions, Co ions, Au ions, and Pt ions.

Examples of the nitrogen reducing agent include hydrazine (N₂H₄), and examples of a material with catalytic activity for an oxidation reaction of the reducing agent include Ni, Co, and Pt. The material of at least the surface of the conductive medium may be at least one of these materials. In this case, the metal ions may be at least one of Ni ions, Co ions, and Pt ions.

Examples of the aldehyde reducing agent include formaldehyde (HCHO), and examples of a material with catalytic activity for an oxidation reaction of the reducing agent include Ag, Cu, and Au. The material of at least the surface of the conductive medium may be at least one of these materials. In this case, the metal ions may be at least one of Ag ions, Cu ions, and Au ions.

Although four specific examples of combinations are described above, preferred embodiments of the present invention are not limited to these four combinations. Namely, a reducing agent suitable for a metal type to be deposited may be selected, and a catalyst material suitable for the reducing agent may be used for the conductive medium. The types of these materials are not specifically limited. The various plating conditions such as the types and concentrations of a complexing agent and additives used, pH, temperature, and mixing conditions are appropriately controlled according to the types of the reducing agent and metal ions used.

To describe a preferred embodiment with respect to the growth of the plating deposits 12a and 12b shown in FIGS. 2 to 5, the distance between the adjacent internal electrodes 3a and 3b measured in the thickness direction of the insulator layers 2 is defined as “s” in FIG. 2 showing the laminate 5 before the formation of the external electrode 8. Further, the withdrawn length of the internal electrodes 3a and 3b from the end surface 6 of the laminate 5 at which the internal electrodes 3 are exposed is defined as “d”. The withdrawn length d varies in the longitudinal direction (perpendicular to the drawing of FIG. 2) of the exposed internal electrode surface, and thus, the length “d” represents an average including this variation in the longitudinal direction.

To facilitate the growth of the plating deposits 12a and 12b, the distance “s” between the adjacent internal electrodes 3a and 3b in the laminate 5 before the formation of the external electrode 8 is preferably about 20 μm or less, and the withdrawn length “d” of the internal electrodes 3a and 3b is preferably about 1 μm or less.

When the distance “s” is about 20 μm or less, the length of plating growth required for the plating deposits 12a and 12b to contact each other as shown in FIGS. 3 and 4 is relatively short, and the probability of contact is increased, thereby facilitating the formation of the first plating layer 10 and improving the density of the first plating layer 10.

When the withdrawn length “d” is about 1 μm or less, the conductive medium easily contacts the exposed portions of the internal electrodes 3a and 3b, thereby facilitating the growth of the plating deposits 12a and 12b. As a result, the first plating layer 10 is easily formed, and the density of the first plating layer 10 is improved.

In a typical example of the multilayer electronic component 1 defining a multilayer ceramic capacitor, the insulator layers 2 are composed of a barium titanate-based dielectric material, and the internal electrodes 3 and 4 are composed of a base metal, such as Ni, Cu, or Ag, as a main component. In the laminate 5 after firing, the internal electrodes 3 and 4 are often significantly recessed inward from the end surfaces 6 and 7 of the laminate 5. In such a case, the withdrawn length “d” may be controlled to about 1 μm or less by cutting the insulator layers 2 using abrading, such as sand blasting or barreling.

Even if the withdrawn length “d” of the internal electrodes 3 and 4 is already about 1 μm or less in the laminate after firing, the above-described abrading is preferably performed to remove the oxide films on the surfaces of the internal electrodes 3 and 4 and to roughen the surfaces of the internal electrodes 3 and 4. In the electroless plating step, the removal of the oxide films improves the adhesion of the plating deposits 12a and 12b to the internal electrodes 3 and 4, and electrons can be easily supplied by the conductive medium.

The abrading also ensures the formation a high density plating film.

It is not necessary that the main component of the internal electrodes 3 and 4 is a metal, such as Pd or Pt, having high catalytic activity during electroless plating. The main component may be a metal, such as Ni, Cu, or Ag, and need not necessarily have catalytic activity for the reducing agent used.

When the main component of the internal electrodes 3 and 4 is Ni, Cu, or Ag; the Ni, Cu, or Ag may form an alloy with another metal component.

In addition, the internal electrodes 3 and 4 need not have a large thickness and a thickness of less than about 1 μm is sufficient. The thickness can be decreased to about 0.2 μm, thereby reducing the cost and the size of the multilayer electronic component 1.

Next, as in this preferred embodiment, when the second plating layer 11 is formed, the second plating layer 11 may be formed on the first plating layer 10 by a known method. In the step of forming the second plating layer 11, a portion to be plated is already a continuous conductive surface, and thus, the second plating layer 11 can be easily formed. The second plating layer 11 can also be formed by electrolytic plating instead of electroless plating.

The external electrodes 8 and 9 is not required to have a two-layer structure as in this preferred embodiment, and instead, may have a single-layer structure or a structure having three or more layers. Examples of the structure include a three-layer structure including a Cu plating layer, a Ni plating layer, and a Sn plating layer formed in that order as first, second, and third plating layers, and a four-layer structure including a Ni plating layer, a Cu plating layer, a Ni plating layer, and a Sn plating layer formed in that order as first, second, third, and fourth plating layers.

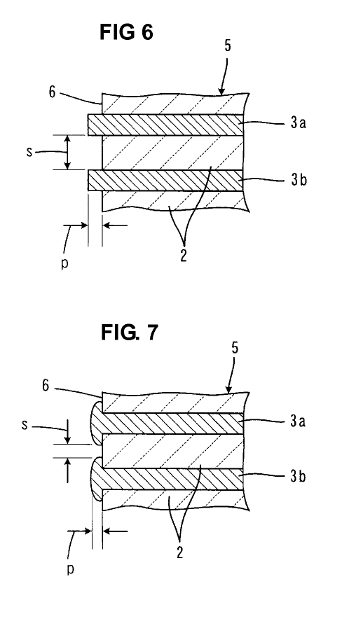

FIG. 6 corresponds to FIG. 2, and illustrates a manufacturing method according to a second preferred embodiment of the present invention. In FIG. 6, components corresponding to those shown in FIG. 2 are denoted by the same reference numerals, and a description thereof is omitted.

The second preferred embodiment includes internal electrodes 3a and 3b that project from the end surface 6. More specifically, in the second preferred embodiment, the protrusion length “p” of the internal electrodes 3a and 3b from the end surface 6 is at least about 0.1 μm, for example. In this preferred embodiment, in the end surface 6 of the laminate 5, the distance “s” between the adjacent internal electrodes 3a and 3b measured in the thickness direction of the insulator layers 2 is not required to be as short as about 20 μm or less, and a distance of about 50 μm or less is sufficient, for example.

The protrusion length “p” varies in the longitudinal direction (perpendicular to the drawing of FIG. 6) of the exposed internal electrode surface, and thus “p” represents an average including this variation in the longitudinal direction.

As described above, when the protrusion length “p” is at least about 0.1 μm, the conductive medium easily contacts the exposed portions of the internal electrodes 3a and 3b, thereby facilitating the growth of the plating deposits 12a and 12b. As a result, the first plating layer 10 can easily be formed, and the density of the first plating layer 10 is improved. In addition, the distance “s” between the internal electrodes can be increased, and the degree of design freedom of the multilayer electronic component is increased.

The other end surface 7 and the internal electrodes 4 exposed therein (refer to FIG. 4) are substantially the same as the end surface 6 and the internal electrodes 3, and thus figures and a description thereof are omitted.

The internal electrodes 3a and 3b may be projected from the end surface 6 by a method of increasing abrading strength or mixing a metal with an abrasive agent to increase the hardness of the abrasive agent. In particular, when the insulator layers 2 are composed of ceramic, the internal electrodes 3a and 3b can easily be projected by controlling the conditions for sand blasting or barreling because ceramic is more easily polished than the internal electrodes 3a and 3b. Further, ceramic can be selectively and effectively polished by laser abrading, and thus, the internal electrodes 3a and 3b can easily be projected.

FIG. 7 corresponds to FIG. 6, for illustrating a manufacturing method according to a third preferred embodiment of the present invention. In FIG. 7, components corresponding to those shown in FIG. 6 are denoted by the same reference numerals, and a description thereof is omitted.

The preferred embodiment shown in FIG. 7 satisfies the condition in which the distance “s” between the adjacent internal electrodes 3a and 3b measured in the thickness direction of the insulator layers 2 is about 50 μm or less, and the protrusion length “p” of the internal electrodes 3a and 3b from the end surface 6 is at least about 0.1 μm, for example.

The preferred embodiment described with reference to FIG. 7 is performed after the step shown in FIG. 6 as required. When the ends of the internal electrodes 3a and 3b project sufficiently from the end surface 6, as shown in FIG. 7, the projected ends of the internal electrodes 3a and 3b are pressed to spread in parallel to the end surface 6 by further abrading. As a result, the protrusion length “p” of each of the internal electrodes 3a and 3b from the end surface 6 is undesirably shorter than the protrusion length “p” in the preferred embodiment shown in FIG. 6. However, the distance “s” between the adjacent internal electrodes 3a and 3b is advantageously shorter than the distance “s” in the preferred embodiment shown in FIG. 6.

In this case, the necessary distance of growth of the plating deposit in electroless plating is substantially decreased. Therefore, the homogeneity of the plating deposit is increased, and the plating efficiency is improved. Also, in this preferred embodiment, even when the insulator layers 2 disposed between the internal electrodes 3a and 3b are relatively thick, the distance “s” between the adjacent internal electrodes 3a and 3b can be decreased.

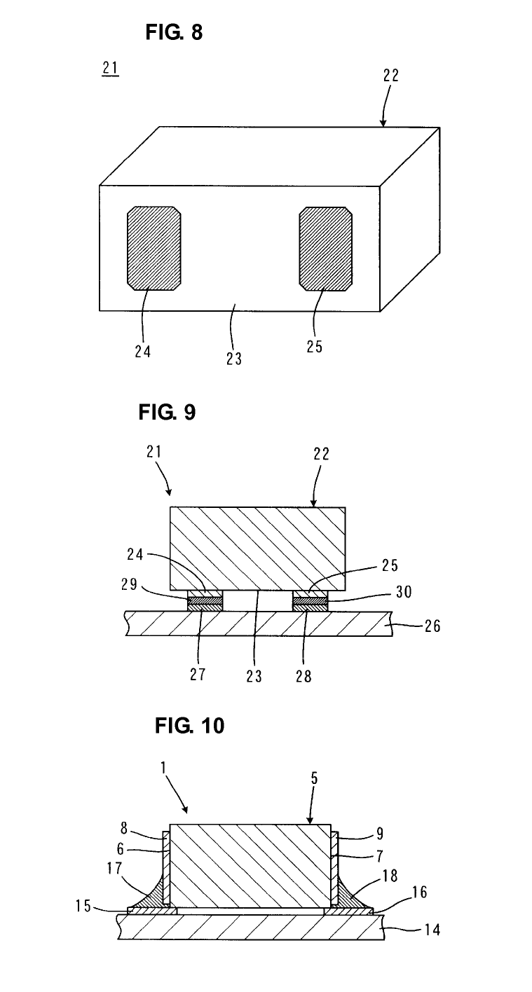

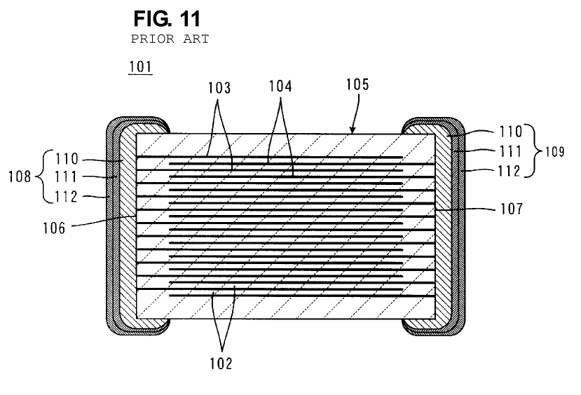

FIG. 8 is a perspective view showing another preferred embodiment of a multilayer electronic component obtained by a manufacturing method according to the present invention.

A multilayer electronic component 21 includes a laminate 22. The multilayer electronic component 21 includes a plurality of external electrodes 24 and 25, e.g., two external electrodes 24 and 25, formed on a specified surface of the laminate 22.

Although not shown in FIG. 8, the laminate 22 includes a plurality of stacked insulator layers and a plurality of internal electrodes formed along the interfaces between the insulator layers. The ends of the internal electrodes are exposed at a surface 23 of the laminate 22 before the external electrodes 24 and 25 are formed. The external electrodes 14 and 15 are formed to electrically connect the ends of the plurality of internal electrodes. When the multilayer electronic component 21 is a multilayer ceramic capacitor, the external electrodes 24 and 25 are formed to provide a capacitance therebetween.

Similar to the multilayer electronic component 1 shown in FIG. 1, the external electrodes 24 and 25 are substantially composed of only a plating deposit. In particular, at least portions of the external terminal electrodes 24 and 25, which are directly connected to the internal electrodes, are composed of an electroless plating deposit.

To manufacture the multilayer electronic component 21 shown in FIG. 8, when each of the external electrodes 24 and 25 is composed of a paste electrode layer, the process is very complicated. This is because a region of the outer surface of the laminate 22 other than a region where each of the external electrodes 24 and 25 is to be formed must be masked, thereby requiring a complicated step such as screen printing. On the other hand, as in this preferred embodiment, when a plating deposit is deposited directly on the end of each the plurality of internal electrodes exposed in the predetermined surface 23 of the laminate 22, masking is not required, thereby significantly simplifying the process. Accordingly, the multilayer electronic component 21 can be efficiently manufactured by the above-described plating method.

FIG. 9 shows a state in which the multilayer electronic component 21 shown in FIG. 8 is mounted on a substrate 26.

Terminals 27 and 28 are formed on a surface of the substrate 26. The external electrodes 24 and 25 provided on the multilayer electronic component 21 are bonded to the terminals 27 and 28 by solder 29 and 30, respectively. In this mounting state, the solder 29 and 30 is present only between the external electrodes 24 and 25 and the terminals 27 and 28, respectively.

FIG. 10 shows a state in which the multilayer electronic component 1 shown in FIG. 1 is mounted on a substrate

In the multilayer electronic component 1 shown in FIG. 1, the external electrodes 8 and 9 are formed on opposite parallel surfaces and not in the same plane. Therefore, when the multilayer electronic component 1 is mounted on the substrate 14, t a substantially perpendicular positional relation between the surface on which each of the external electrodes 8 and 9 is positioned and the surface of the substrate 14 on which the terminals 15 and 16 are positioned is achieved. In this case, solder 17 and 18 for bonding the external electrodes 8 and 9 to the terminals 15 and 16, respectively, is formed in a fillet shape having at least a desired thickness.

Therefore, in the mounting state shown in FIG. 9, the solder 29 and 30 is not formed in a fillet shape because the external electrodes 24 and 25 are disposed in the same plane, and accordingly, the mounting density on the substrate 26 can be increased, as compared with the mounting state shown in FIG. 10.

When the multilayer electronic component 21 is a multilayer ceramic capacitor, in the mounting state as shown in FIG. 9 in which the amount of the solder 29 and 30 is relatively small, equivalent series inductance (ESL) is decreased. As a result, a phase shift amount in charging and discharging of the capacitor is decreased, and thus, the capacitor is particularly practical for high-frequency applications. Therefore, the structure used for the multilayer electronic component 21 can be suitably used for low-ESL multilayer capacitor.

Although the present invention is described with reference to the preferred embodiments shown in the drawings, various modifications can be made within the scope of the present invention.

For example, a multilayer chip capacitor is a typical a multilayer electronic component to which preferred embodiments of the present invention are applied. However, preferred embodiments of the present invention can be applied to a multilayer chip inductor, a multilayer chip thermistor, and other suitable multilayer electronic components.

Therefore, the material for the insulator layers provided in a multilayer electronic component is not particularly limited as long as the insulator layers are electrically insulating. The material of the insulator layers is not limited to dielectric ceramic, and piezoelectric ceramic; and semiconductor ceramic, magnetic ceramic, and resins may also be used.

Hereinafter, a description is provided of experimental examples produced to determine the scope of the present invention and confirming the advantages of the present invention.

Table 1 below shows the four types of electroless plating conditions A to D used in the experimental examples.

TABLE 1

| | |
|---|---|
| A | Nickel(II) sulfate hexahydrate: 0.1 mol/L |
| | Sodium hypophosphite monohydrate: 0.2 mol/L |
| | Gluconolactone: 0.3 mol/L |
| | Bismuth sulfate: 1 × 10⁻⁵ mol/L |
| | pH: 7.0 |
| | Temperature: 65° C. |
| | Rotation condition: at 10 rpm for 100 min |
| B | Nickel(II) sulfate hexahydrate: 0.1 mol/L |
| | Dimethylaminoborane: 0.05 mol/L |
| | Trisodium citrate dihydrate: 0.15 mol/L |
| | Lactic acid: 0.28 mol/L |
| | pH: 7.0 |
| | Temperature: 55° C. |
| | Rotation condition: at 10 rpm for 150 min |
| C | Nickel chloride hexahydrate: 0.1 mol/L |
| | Hydrazine monohydrate: 0.6 mol/L |
| | Trisodium citrate dihydrate: 0.2 mol/L |
| | pH: 9.5 |
| | Temperature: 80° C. |
| | Rotation condition: at 10 rpm for 150 min |
| D | Copper sulfate pentahydrate: 0.04 mol/L |
| | Formaldehyde: 0.16 mol/l |
| | Potassium sodium tartrate: 0.1 mol/L |
| | Polyethylene glycol: 1.0 g/L |
| | Sodium hydroxide: 0.125 mol/L |
| | Temperature: 40° C. |
| | Aeration: 0.5 L/min |
| | Rotation condition: at 10 rpm for 150 min |

### Experimental Example 1

In Experimental Example 1, conductive media made of different materials were prepared for use in electroless plating. In a multilayer electronic component shown in FIG. 1, the influences of the materials used for the conductive media were examined when a first plating layer was formed, by electroless plating, directly on each of the end surfaces of a laminate in which internal electrodes were exposed.

In detail, a multilayer ceramic capacitor laminate having a length of about 1.6 mm, a width of about 0.8 mm, and a thickness of about 0.8 mm was prepared as a material to be plated, and the laminate included insulator layers composed of a barium titanate-based dielectric material and internal electrodes, the thickness and the main component of the internal electrodes being as shown in “Thickness of internal electrode” and “Main component of internal electrode” in Table 2. In the laminate, the thickness of the insulator layers, i.e., the distance “s” between the adjacent internal electrodes was about 10 μm, and the maximum withdrawn length “d” of the internal electrodes at each of the end surfaces of the laminate at which the internal electrodes were exposed, was about 2.0 μm.

Next, 5000 of the laminates and 80 cc of each of the conductive media having a diameter of about 0.4 mm were disposed in a rotary barrel having a volume of about 300 cc, and an electroless Ni plating film having a thickness of about 8 μm was formed as a first plating layer on each of the end surfaces of the laminate at which the internal were exposed, under the conditions A shown in Table 1 as shown in “Plating condition” in Table 2. In this case, the material of each conductive medium used was either Fe or Ni as shown in the column “Type of conductive medium” in Table 2.

Next, the rotary barrel containing the laminates each including the electroless Ni plating film formed as the first plating layer was immersed in a Sn plating bath (Sn-235 manufactured by Dipsol Co., Ltd.) at a temperature of about 33° C. and pH set to about 5.0. Further, a current was supplied through a feed terminal for about 50 minutes at a current density of about 0.07 A/dm² while the rotary barrel was rotated at a rotational speed of 12 rpm. As a result, a Sn plating film having a thickness of about 3 μm was formed as a second plating layer on each of the first plating layers.

As described above, the plating layers can be formed directly on the laminate without the formation of paste electrode layers. As a result, the multilayer ceramic capacitors of Samples 1 to 3 each including the external electrodes composed of the plating layers were obtained.

Next, 100 of the multilayer ceramic capacitors of each of Samples 1 to 3 were subjected to a high-temperature load test (105° C., 12.6 V) in order to measure an insulation resistance value after about 1000 hours and about 2000 hours. When the insulation resistance was about 1 MΩ or less, the capacitors were counted as defective capacitors. Table 2 shows the number of defective capacitors.

TABLE 2

| | | | | | | High-temperature | High-temperature |
|---|---|---|---|---|---|---|---|
| | Thickness | Main | | | | load test (1000 | load test (2000 |
| | of internal | component of | Type of | | | hours) | hours) |
| Sample | electrode | internal | conductive | Plating | Plating | Number of | Number of |
| No. | [μm] | electrode | medium | metal | condition | defectives | defectives |
| 1 | 1.0 | Pd | Fe | Ni | A | 51/100 | 84/100 |
| 2 | 1.0 | Ni | Fe | Ni | A | 90/100 | 100/100 |
| 3 | 1.0 | Ni | Ni | Ni | A | 0/100 | 3/100 |

Table 2 indicates that Sample 1 had a large number of defective capacitors and insufficient reliability. This is possibly due to the fact that a Sn plating solution penetrates into the laminate because of the low density of the first plating layer, thereby corroding to some extent the insulator layers and the internal electrodes in the laminate.

Sample 2 shows a larger number of defective capacitors and insufficient reliability as compared to Sample 1. This is possibly due to the fact that the density of the first plating layers is further decreased because the main component of the internal electrodes is Ni which has a low catalytic function.

On the other hand, Sample 3 has no defects after 1000 hours and thus has high reliability. This is possibly due to the fact that the surface material of the conductive medium is Ni having catalytic activity for a reducing agent, thereby increasing the density of the first plating layers. This result indicates that even when the internal electrodes of the laminate are composed of a base metal having low catalytic ability, such as Ni, as a main component, the first plating layers having high density are obtained.

### Experimental Example 2

In Experimental Example 2, the influence of the thickness of internal electrodes in a laminate on the quality of electroless plating was examined.

The same laminate as in Experimental Example 1 was used as a material to be plated except that the thickness and the main component of the internal electrodes were as shown in “Thickness of internal electrode” and “Main component of internal electrode” in Table 3.

Next, 5000 of the laminates and about 50 cc of each conductive medium having a diameter of about 0.2 mm were placed in a rotary barrel having a volume of about 300 cc, and an electroless Ni plating film having a thickness of about 8 μm was formed as a first plating layer on each of the end surfaces of each laminate, at which the internal electrodes were exposed, under the conditions A shown in Table 1 as shown in “Plating condition” in Table 3. In this case, the material of the conductive medium used was either Fe or Ni as shown in the column “Type of conductive medium” in Table 3.

Next, a Sn plating layer having a thickness of about 3 μm was formed as a second plating layer on each of the first plating layer by the same method as used in Experimental Example 1.

As described above, the plating layers can be formed directly on the laminate without the formation of paste electrode layers. As a result, multilayer ceramic capacitors of Samples 11 to 15 including the external electrodes composed of the plating layers were obtained.

Next, 100 of the multilayer ceramic capacitors of each of Samples 11 to 15 were subjected to a high-temperature load test under the same conditions as in Experimental Example 1 in order to measure an insulation resistance value after about 1000 hours and about 2000 hours. When the insulation resistance was about 1 MΩ or less, the capacitors were counted as defective capacitors. Table 3 shows the number of defective capacitors.

TABLE 3

| | | | | | | High-temperature | High-temperature |
|---|---|---|---|---|---|---|---|
| | Thickness | Main | | | | load test (1000 | load test (2000 |
| | of internal | component of | Type of | | | hours) | hours) |
| Sample | electrode | internal | conductive | Plating | Plating | Number of | Number of |
| No. | [μm] | electrode | medium | metal | condition | defectives | defectives |
| 11 | 0.8 | Ni | Ni | Ni | A | 0/100 | 5/100 |
| 12 | 0.4 | Ni | Ni | Ni | A | 0/100 | 7/100 |
| 13 | 0.2 | Ni | Ni | Ni | A | 0/100 | 8/100 |
| 14 | 0.8 | Pd | Fe | Ni | A | 69/100 | 94/100 |
| 15 | 0.4 | Pd | Fe | Ni | A | 92/100 | 100/100 |

Table 3 indicates that Samples 11 to 13 have no defects in the high-temperature load test and the same reliability as in Sample 3 of Experimental Example 1 even when the thickness of the internal electrodes is less than about 1.0 μm, for example, about 0.2 μm. This is because the surface material of each conductive medium is Ni which has catalytic activity for a reducing agent.

On the other hand, in Samples 14 and 15, the density of the first plating layers is further decreased which decreases reliability because the thickness of the internal electrodes is less than that in Sample 1 of Experimental Example 1.

These results indicate that even when the thickness of internal electrodes is as small as less than about 1.0 μm, a first plating layer having high density can be formed by the electroless plating method according to preferred embodiments of the present invention.

### Experimental Example 3

In Experimental Example 3, the influence of barreling before electroless plating was examined, and first plating layers were formed by electroless plating using various metal ions or reducing agents.

The same laminate as in Experimental Example 1 was used as a material to be plated except that the thickness and the main component of the internal electrodes were as shown in “Thickness of internal electrode” and “Main component of internal electrode” in Table 4. Therefore, the withdrawn length “d” of the internal electrodes from each of the end surfaces of the laminate, in which the internal electrodes were exposed, was about 2.0 μm which was the same as in Experimental Example 1.

Next, as shown in Table 4, the laminate of each of Samples 22, 23, 24, 25, 26, 28, and 30 was barreled with an abrasive agent so that the maximum withdrawn length “d” of the internal electrodes from each of the end surfaces of the laminate, in which the internal electrodes were exposed, was about 0.1 μm. On the other hand, the laminates of Samples 21, 27, and 29 were not barreled. Therefore, the withdrawn length “d” of the internal electrodes was maintained at about 2.0 μm.

Next, 5000 of the laminates and about 100 cc of each conductive medium having a diameter of about 0.4 mm were placed in a rotary barrel having a volume of about 300 cc, and an electroless plating film having a thickness of about 10 μm was formed as a first plating layer on each of the end surfaces of each laminate, in which the internal electrodes were exposed, under the conditions A, B, C, or D shown in Table 1 as shown in “Plating condition” in Table 4. In this case, as shown in the column “Plating metal”, electroless Ni plating films were formed in Samples 21 to 26, and electroless Cu plating films were formed in Samples 27 to 30. Also, the material of each conductive medium used was one of Ni, Cu, and Ag as shown in the column “Conductive medium type” in Table 4.

Next, in Samples 21 to 26, a Sn plating layer having a thickness of about 5 μm was formed as a second plating layer on each of the first plating layer by the same method as used Experimental Example 1.

On the other hand, in Samples 27 to 30, the rotary barrel containing the laminates including the first plating layer was immersed in a Ni plating Watts bath at a temperature of about 60° C. and pH set to about 4.2. Further, a current was supplied at a current density of about 0.2 A/dm² while the rotary barrel was rotated at a rotational speed of about 10 rpm. Sixty minutes after the start of current supply, a Ni plating film having a thickness of about 5 μm was formed as a second plating layer. Further, the rotary barrel containing the laminates including the second plating layer was immersed in a Sn plating bath (Sn-235 manufactured by Dipsol Co., Ltd.) at a temperature of about 33° C. and pH set to about 5.0. Further, a current was supplied through a feed terminal at a current density of about 0.07 A/dm² for about 50 minutes while the rotary barrel was rotated at a rotational speed of about 12 rpm. As a result, a Sn plating film having a thickness of about 5 μm was formed as a third plating layer.

As described above, the plating layers can be formed directly on the laminate without the formation of paste electrode layers. As a result, multilayer ceramic capacitors of Samples 21 to 30 including the external electrodes composed of the plating layers were obtained.

Next, 100 of the multilayer ceramic capacitors of each of Samples 21 to 30 were subjected to a high-temperature load test under the same conditions as in Experimental Example 1 in order to measure an insulation resistance value after about 1000 hours and about 2000 hours. When the insulation resistance was about 1 MΩ or less, the capacitors were counted as defective capacitors. Table 4 shows the number of defective capacitors.

TABLE 4

| | | Main | | | | | High-temperature | High-temperature |
|---|---|---|---|---|---|---|---|---|
| | Thickness | component | | | | | load test (1000 | load test (2000 |
| | of internal | of | Type of | | | | hours) | hours) |
| Sample | electrode | internal | conductive | d | Plating | Plating | Number of | Number of |
| No. | [μm] | electrode | medium | [μm] | metal | condition | defectives | defectives |
| 21 | 0.6 | Ni | Ni | 2.0 | Ni | A | 0/100 | 5/100 |
| 22 | 0.6 | Ni | Ni | 0.1 | Ni | A | 0/100 | 0/100 |
| 23 | 0.6 | Cu | Ni | 0.1 | Ni | A | 0/100 | 0/100 |
| 24 | 0.6 | Ag | Ni | 0.1 | Ni | A | 0/100 | 0/100 |
| 25 | 0.6 | Ni | Ni | 0.1 | Ni | B | 0/100 | 0/100 |
| 26 | 0.6 | Ni | Ni | 0.1 | Ni | C | 0/100 | 0/100 |
| 27 | 0.6 | Ni | Cu | 2.0 | Cu | D | 0/100 | 7/100 |
| 28 | 0.6 | Ni | Cu | 0.1 | Cu | D | 0/100 | 0/100 |
| 29 | 0.6 | Ni | Ag | 2.0 | Cu | D | 0/100 | 8/100 |
| 30 | 0.6 | Ni | Ag | 0.1 | Cu | D | 0/100 | 0/100 |

Table 4 shows that all samples show no defective capacitor after about 1000 hours and thus had excellent reliability. In particular, Samples 22, 23, 24, 25, 26, 28, and 30 subjected to barreling had no defective product after about 2000 hours and thus had even greater reliability. This is possibly due to the fact that the withdrawn length “d” of the internal electrodes from the end surfaces of the laminates is decreased to about 1 μm or less by barreling, and thus, the conductive medium having catalytic activity are easily brought into contact with the exposed ends of the internal electrodes, thereby further improving the density of the plating films.

Also the results of Samples 23 and 24 show that even when the main component of the internal electrodes is either Cu or Ag, the first plating layers having high density and reliability can be formed.

Further, the results of Samples 25 and 26 show that when the conductive medium has catalytic activity for a reducing agent, various reducing agents can be used.

In addition, the results of Samples 27 to 30 show that first plating layers with high density and excellent reliability can be formed by electroless Cu plating.

### Experimental Example 4

Experimental Example 4 was performed to confirm that when internal electrodes project from an end surface of a laminate, the laminate may have a larger distance “s” between the internal electrodes (thickness of insulator layers).

The same laminate as in Experimental Example 3 was used as a material to be plated except that the main component of the internal electrodes were constantly Ni, and the thickness of the insulator layers of the laminate were about 20 μm and about 50 μm as shown in “Thickness of insulator layer” in Table 5.

Next, the laminate of each of the samples was subjected to sand blasting with an alumina abrasive powder. As shown in Table 5, the laminates of Samples 31 and 32 were subjected to sand blasting with a strength of about 0.25 MPa so that the maximum withdrawn length “d” of the internal electrodes from each of the end surfaces of the laminate at which the internal electrodes were exposed was about 0.1 μm. On the other hand, the laminates of Samples 33 and 34 were subjected to sand blasting with a strength of about 0.50 MPa so that the average protrusion length “p” of the internal electrodes from each of the end surfaces of the laminate at which the internal electrodes were exposed was about 1 μm.

After the sand blasting, the laminates were washed to remove the abrasive powder and then dried.

Next, electroless plating films having a thickness of about 10 μm were formed as first plating layers under the same conditions as in Experimental Example 1, except that the material of each conductive medium used was constantly Ni as shown in the column “Type of conductive medium” of Table. 5. Then, Sn plating films having a thickness of about 5 μm were formed as second plating layers on the first plating layers under the same conditions as in Experimental Example 1.

As described above, the plating layers can be formed directly on the laminate without the formation of paste electrode layers. As a result, multilayer ceramic capacitors of Samples 31 to 34 including the external electrodes composed of the plating layers were obtained.

Next, 100 of the multilayer ceramic capacitors of each of Samples 31 to 34 were subjected to a high-temperature load test under the same conditions as in Experimental Example 1 in order to measure an insulation resistance value after about 1000 hours and about 2000 hours. When the insulation resistance was about 1 MΩ or less, the capacitors were counted as defective capacitors. Table 5 shows the number of defective capacitors.

TABLE 5

| | | | | | | | | High- | High- |
|---|---|---|---|---|---|---|---|---|---|
| | | Main | | | | | | temperature | temperature |
| | Thickness | component | | | | | Thickness | load test | load test |
| | of internal | of | Type of | | | | of | (1000 hours) | (2000 hours) |
| Sample | electrode | internal | conductive | d or p | Plating | Plating | insulator | Number of | Number of |
| No. | [μm] | electrode | medium | [μm] | metal | condition | layer [μm] | defectives | defectives |
| 31 | 0.6 | Ni | Ni | d = 0.1 | Ni | A | 20 | 0/100 | 0/100 |
| 32 | 0.6 | Ni | Ni | d = 0.1 | Ni | A | 50 | 52/100 | 100/100 |
| 33 | 0.6 | Ni | Ni | P = 1 | Ni | A | 20 | 0/100 | 0/100 |
| 34 | 0.6 | Ni | Ni | P = 1 | Ni | A | 50 | 0/100 | 0/100 |

As shown in Table 5 each of Samples 31 and 32 have d=0.1. Sample 31 in which the thickness of the insulator layers is about 20 μm had no defective product after about 1000 hours and about 2000 hours, and thus, had excellent reliability, while Sample 32 in which the thickness of the insulator layers is about 50 μm had defects after about 1000 hours.

On the other hand, Samples 33 and 34, in which p=1, had no defective product after about 1000 hours and about 2000 hours, and thus had excellent reliability. These results indicate that when internal electrodes project from an end surface of a laminate, the reliability of a multilayer electronic component can be improved even if the thickness of insulator layers, i.e., the distance “s” between the internal electrodes, is about 20 μm or more.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A method of manufacturing a multilayer electronic component, the method comprising:
a step of preparing a laminate including a plurality of stacked insulator layers and a plurality of internal electrodes formed along interfaces between the respective insulator layers, the ends of the internal electrodes being exposed at a predetermined surface and the internal electrodes located adjacent to each other are electrically insulated from each other at the predetermined surface; and
a step of forming at least one external electrode on the predetermined surface of the laminate so that the ends of the plurality of internal electrodes exposed at the predetermined surface of the laminate are electrically connected to each other; wherein
the step of forming the at least one external electrode includes an electroless plating step of electroless plating a deposit on the ends of the plurality of internal electrodes, which are exposed at the predetermined surface of the laminate prepared in the step of preparing the laminate, using a reducing agent and a plating solution including metal ions having a deposition potential that is more electrochemically positive than an oxidation-reduction potential of the reducing agent; and
the electroless plating step includes a step of preparing a conductive medium having catalytic activity for an oxidation reaction of the reducing agent, a step of stirring the conductive medium and the laminate in the plating solution, and a step of growing the plating deposits on the ends of the plurality of internal electrodes so that the plating deposits are connected to each other.

2. The method according to claim 1, wherein the step of stirring the conductive medium and the laminate in the plating solution is performed by at least one of rotating, shaking, inclining, and vibrating the conductive medium and the laminate in the plating solution contained in a vessel.

3. The method according to claim 1, wherein an average diameter of the conductive medium is at least about 0.2 mm.

4. The method according to claim 1, wherein the metal ions in the plating solution are at least one of Ni ions, Co ions, and Au ions, at least a surface of the conductive medium is composed of at least one of Au, Ni, Co, and Pt, or an alloy thereof, and the reducing agent is a phosphoric acid compound.

5. The method according to claim 4, wherein the phosphoric acid compound is one of a hypophosphorous acid and a hypophosphite, and the metal ions in the plating solution are Ni ions.

6. The method according to claim 1, wherein the metal ions in the plating solution are at least one of Ni ions, Co ions, Pt ions, and Au ions, at least a surface of the conductive medium is composed of at least one of Au, Ni, Co, and Pt, or an alloy thereof, and the reducing agent is a boric acid compound.

7. The method according to claim 1, wherein the metal ions in the plating solution are at least one of Ni ions, Co ions, Pt ions, and Au ions, at least a surface of the conductive medium is composed of at least one of Co, Ni, and Pt, or an alloy thereof, and the reducing agent is a nitrogen compound.

8. The method according to claim 1, wherein the metal ions in the plating solution are at least one of Ag ions, Cu ions, and Au ions, at least a surface of the conductive medium is composed of at least one of Ag, Cu, and Au, or an alloy thereof, and the reducing agent is an aldehyde compound.

9. The method according to claim 1, wherein in the laminate prepared in the step of preparing the laminate, a distance between the adjacent internal electrodes, which is measured in a thickness direction of the insulator layers in the predetermined surface at which the internal electrodes are exposed, is about 20 μm or less, and a withdrawn length of the internal electrodes from the predetermined surface is about 1 μm or less.

10. The method according to claim 1, wherein in the laminate prepared in the step of preparing the laminate, a distance between the adjacent internal electrodes, which is measured in a thickness direction of the insulator layers in the predetermined surface at which the internal electrodes are exposed, is about 50 μm or less, and a protrusion length of the internal electrodes from the predetermined surface is at least about 0.1 μm.

11. The method according to claim 9, further comprising a step of abrading the laminate with an abrasive agent before the step of forming the at least one external electrode.

12. The method according to claim 10, further comprising a step of abrading the laminate with an abrasive agent before the step of forming the external electrode.

13. The method according to claim 1, wherein a main component of the internal electrodes is at least one of Ni, Cu, and Ag.
